(19) United States
(12) Patent Application Publication
(10) Pub. No.: US 2024/0084188 A1
(43) Pub. Date: Mar. 14, 2024

(54) SUPER HYDROPHOBIC 2D NANOSHEET MATERIALS FOR IMPROVED OIL RECOVERY

(71) Applicant: SAUDI ARABIAN OIL COMPANY, Dhahran (SA)

(72) Inventors: Abdulaziz S. Al-Qasim, Dammam (SA); Yuguo Wang, Dhahran (SA)

(73) Assignee: SAUDI ARABIAN OIL COMPANY, Dhahran (SA)

(21) Appl. No.: 18/508,715

(22) Filed: Nov. 14, 2023

Related U.S. Application Data
(63) Continuation of application No. 17/213,411, filed on Mar. 26, 2021.

(51) Int. Cl. C09K 8/594; E21B 43/16

(52) U.S. Cl. CPC C09K 8/594; E21B 43/164

(57) ABSTRACT

A dispersion of capsules in critical or supercritical carbon dioxide is provided. The capsules include an aqueous solution encapsulated by 2-dimensional particles. Also provided is a method of making a dispersion of aqueous solution capsules. The method includes providing a medium of critical or supercritical carbon dioxide, introducing the aqueous solution into the critical or supercritical carbon dioxide medium, and introducing a 2-dimensional particle into the critical or supercritical carbon dioxide medium. Associated methods of using the disclosed dispersions in hydrocarbon-bearing formations are also provided.

### BACKGROUND

During primary oil recovery, oil inside an underground hydrocarbon reservoir is driven to the surface (for example, toward the surface of an oil well) by a pressure difference between the reservoir and the surface. However, only a fraction of the oil in an underground hydrocarbon reservoir can be extracted using primary oil recovery. Thus, a variety of techniques for enhanced oil recovery are utilized after primary oil recovery to increase the production of hydrocarbons from hydrocarbon-bearing formations. Some examples of these techniques include water flooding, chemical flooding, and supercritical CO₂ injection.

Supercritical CO₂ is an useful fluid for enhanced oil recovery applications due to its chemical and physical properties. As well, injecting CO₂ provides the opportunity to sequester a greenhouse gas into a subterranean area. Supercritical CO₂ is miscible with hydrocarbons. Thus, when it contacts hydrocarbon fluid in a reservoir, the fluid is displaced from the rock surfaces and pushed toward the production well. Additionally, CO₂ may dissolve in the hydrocarbon fluid, reducing its viscosity and causing it to swell. This further enhances the ability to recover hydrocarbons and increase production.

### SUMMARY

This summary is provided to introduce a selection of concepts that are further described in the detailed description. This summary is not intended to identify key or essential features of the claimed subject matter, nor is it intended to be used as an aid in limiting the scope of the claimed subject matter.

In one aspect, embodiments disclosed relate to an aqueous solution encapsulated by 2-dimensional particles.

In another aspect, embodiments disclosed relate to a dispersion of capsules in critical or supercritical carbon dioxide, the capsules comprising an aqueous solution encapsulated by (two-dimensional) 2D particles.

In yet another aspect, embodiments disclosed relate to a method of making a dispersion of aqueous solution capsules. The method includes providing a medium of critical or supercritical carbon dioxide, introducing the aqueous solution into the critical or supercritical carbon dioxide medium, and introducing a 2D particle into the critical or supercritical carbon dioxide medium.

In another aspect, embodiments disclosed relate to a method of treating a hydrocarbon-bearing formation. The method includes introducing into a hydrocarbon-bearing formation a dispersion of aqueous solution capsules in a medium of critical or supercritical carbon dioxide. The aqueous solution capsules include an aqueous solution encapsulated by 2D particles.

Other aspects and advantages of the claimed subject matter will be apparent from the following description and the appended claims.

### BRIEF DESCRIPTION OF DRAWINGS

FIG. 1 shows a simplified schematic of an embodiment capsule useful for treating hydrocarbon-bearing formations.

FIG. 2 shows a simplified schematic of an embodiment dispersion in use in a hydrocarbon-bearing formation.

FIG. 3 is a block flow diagram of an embodiment method of making a dispersion.

FIG. 4 is a simplified schematic of an embodiment hydrocarbon bearing formation.

### DETAILED DESCRIPTION

Carbon dioxide (CO₂) is widely used in flooding processes for enhanced oil recovery. While it can be effective for oil recovery due to its affinity for hydrocarbons and its ability to be readily used in its supercritical state in hydrocarbon-bearing formations, it suffers from a number of challenges in field use. The density of CO₂ is less than many of the fluids present in subterranean formations, including water and the liquid and semi-solid hydrocarbons. Due to its reduced density, CO₂ has a tendency to seek upward-directed flow paths in the reservoir as it progresses away from the injection point and through the reservoir. This may lead to the introduced CO₂ preferentially bypassing portions of the reservoir and leaving oil untreated. This phenomenon is called “gravity override.”

The present disclosure relates to compositions and methods for increasing and maintaining density of supercritical CO₂ by adding an aqueous solution encapsulated by effectively 2-dimensional (2D) particles to critical or supercritical CO₂. The CO₂ dispersions described here provide a critical or supercritical CO₂ composition with increased density that does not suffer from the gravity override effect. Such compositions lead to improved sweep efficiency and enhanced oil recovery of the hydrocarbon-bearing formation.

### Capsules of Aqueous Solution

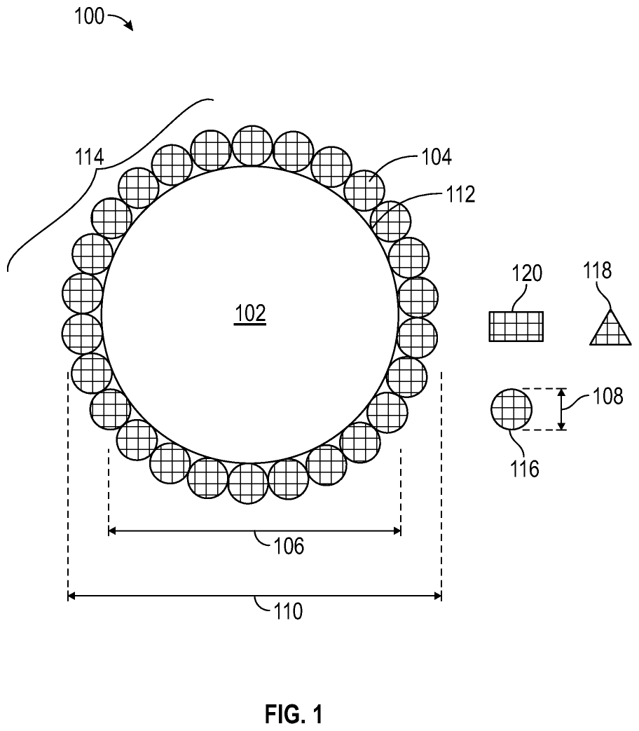

In one aspect, embodiment capsules disclosed relate to an aqueous solution encapsulated by 2D particles. FIG. 1 shows a simplified schematic of an embodiment capsule useful for treating subterranean formations. FIG. 1 shows a capsule 100 having an aqueous solution 102 that is encapsulated by 2-dimensional (2D) particles 104. The aqueous solution 102 as given in capsule 100 has a solution diameter 106. The 2D particles 104 have a 2D particle diameter 108. The capsule 100 has a capsule diameter 110. In the embodiment shown in FIG. 1, the surface 112 of the aqueous solution 102 is surrounded by a layer of 2D particles 104 which form an encapsulating shell 114 around the aqueous solution 102 such that it is encapsulated. Several potential shapes of the 2D particles 104 are represented, such as circular 116, triangular 118, and square 120.

Embodiment capsules include an aqueous solution. For embodiment capsules, the aqueous solution includes water. The water may comprise one or more known compositions of water, including distilled; condensed; filtered or unfiltered fresh surface or subterranean waters, such as water sourced from lakes, rivers or aquifers; mineral waters; gray water; run-off, storm or waste water; potable or non-potable waters; brackish waters; synthetic or natural sea waters; synthetic or natural brines; formation waters; production water; and combinations thereof.

In some embodiments, the aqueous solution may also include one or more chemical additives. Embodiment chemical additives may include emulsifying agents, gelling agents, foaming agents and surfactants.

In some embodiments, within the embodiment capsule the aqueous solution is in the form of a liquid, for example, a droplet or sphere. In such embodiments, the solution diameter may have a range of from about 10 nm (nanometers) to about 100 μm (micrometers), meaning the aqueous solution diameters have a D₁ of about 10 nm and a D₉₉ of about 100 μm. In some embodiments, the solution diameter may have a range of from about 10 nm to 200 nm. In other embodiments, the solution diameter may have a range of from about 10 μm to 100 μm. A D₁ value means that 1% of the aqueous solutions have a diameter of less than the D₁ value. A D₉₉ value means that 99% of the aqueous solutions have a diameter of less than the D₉₉ value.

Embodiment capsules also include a 2-dimensional (2D) particle. As described here, a 2-dimensional particle is a sheet of material that is effectively 2-dimensional, meaning the thickness of the particle is negligibly small. Such sheets may only be several atomic layers thick. As such, the 2-dimensional particles generally have a length and width of at least 10 nanometers, and a maximum thickness of about one nanometer. In one or more embodiments, the 2D particle is not greater than three atomic layers in thickness.

Embodiment capsules may include non-metallic materials, such as graphene and boron nitride. In some embodiments, the 2D particle is graphene. Embodiment graphene may be made by any suitable method, such as chemical exfoliation of graphite. Embodiment graphene may have a hexagonal crystal structure. Embodiment graphene has a bulk density of from about 0.03 to about 1.0 g/cm² (grams per centimeter squared) and a skeletal density of about 2.267 g/cm².

In some embodiments, the 2D particle is boron nitride. In some embodiments, the boron nitride may have a hexagonal crystal structure and be referred to as hexagonal boron nitride (hereafter “h-BN”). Embodiment h-BN may be made by any suitable method, including bottom up (for example, film deposition) and top down (for example, chemical or mechanical exfoliation) methods. Embodiment h-BN has a bulk density of about 0.3 g/cm² and a skeletal density of about 2.25 g/cm².

On the macro-scale, embodiment 2-dimensional particles may be any appropriate shape useful for encapsulating aqueous solutions. For example, as shown in FIG. 1, 2D particles are shown as circular 116, square 120, and triangular 118; however, geometric and non-geometric configurations are not limited except as to provide for an encapsulating surface for the aqueous solution.

Embodiment 2-dimensional particles may be any appropriate size for encapsulating aqueous solutions. Based upon the configuration or geometry of the form of the 2D particle, the particle size may be determined by a center-traversing axis parallel with its longest length. So, for example, a circle may be measured by its diameter; a square by its diagonal. In some embodiments, the 2D particles have a particle size in a range of from about 100 to about 400 nm (nanometers), meaning the 2D particles have a D₁ of about 100 nm and a D₉₉ of about 400 nm. A D₁ value means that 1% of the 2D particles have a diameter of less than the D₁ value. A D₉₉ value means that 99% of the particles have a diameter of less than the D₉₉ value.

In some embodiments, the 2D particles are hydrophobic. In such embodiments, the water contact angle of embodiment 2D particles is from about 90° to about 180°. In some embodiments, the water contact angle of embodiment 2D particles is less than 120° or less than 150°. Embodiment graphene may have a water contact angle of from about 95° to 130°. Embodiment h-BN may have a water contact angle of up to 150°.

Embodiment 2D particles may have an appropriate BET surface area for use in supercritical CO₂ environments. As used here, “BET surface area” refers to the average surface area of the COF particles as measured by the BET (Brunauer Emmet Teller) nitrogen absorption method according to ASTM D-6556. BET surface area is reported in meters squared per gram of material. As will be explained in greater detail, in embodiment dispersions, supercritical CO₂ adsorbs on the surface of hydrophobic 2D particles. Without wishing to be bound by any particular mechanism or theory, it is believed that by tuning the surface area of embodiment 2D particles, the amount of CO₂ adsorption to the surface of the 2D particles may be tuned. That is, it is believed that increasing particle surface area will result in greater amounts of CO₂ being absorbed by the 2D particle, and vice versa. In turn, greater amounts of CO₂ concentrated in a smaller volume results in a further densification of the bulk SCCO2 medium.

In some embodiments, the BET surface area of the COFs may be from about 2200 to about 2600 m²/g (meters squared per gram). In some embodiments, the BET surface area of embodiment 2D particles may have a lower limit of one of 2200, 2250, 2300, 2350 and 2400 m²/g, and an upper limit of one of 2450, 2500, 2550 and 2600 m²/g, where any lower limit may be paired with any mathematically compatible upper limit.

As described, embodiment capsules include an aqueous solution that is encapsulated by 2D particles. The aqueous solution is surrounded by the 2D particles and does not disperse into the medium hosting the capsules. In embodiment capsules, the aqueous solution and the 2D particles are as previously described.

In some embodiments, capsules have a capsule size range, which is effectively the diameter of the capsule, from about a few nanometers to a few millimeters. The capsule size range for a given embodiment capsule should be approximately the same in all directions of the roughly spherical shape; however, variations in configuration between a given 2D particle and another may provide some statistically insignificant differences in determined capsule size range based on one diameter versus another. In such embodiments, the capsule diameter may have a range of from about 10 nm (nanometers) to about 100 μm (micrometers), meaning the capsules have a D₁ of about 10 nm and a D₉₉ of about 100 μm. In some embodiments, the capsule diameter may have a range of from about 10 nm to 200 nm. In other embodiments, the capsule diameter may have a range of from about 10 μm to 100 μm.

Embodiment capsules have a density in a range of from about 0.9 to 1.2 g/mL (grams per milliliter).

### Dispersion of Capsules in Super/Critical CO2

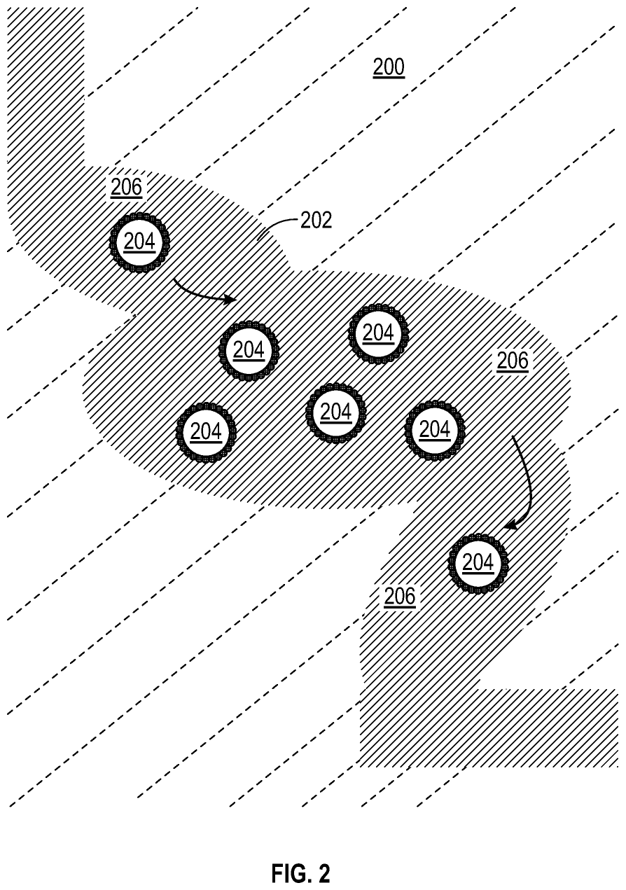

In another aspect, embodiments disclosed relate to a dispersion of the embodiment capsules previously described. FIG. 2 shows a simplified schematic of an embodiment dispersion in use in a hydrocarbon-bearing formation. A hydrocarbon-bearing formation 200 has pores 206 throughout. An embodiment dispersion within pores 206 may include carbon dioxide (CO₂) either at the critical state or in a supercritical state (referred to collectively as “SCCO2”) 202 and capsules 204. Arrows (not labeled) show the direction of flow of the embodiment dispersion through the hydrocarbon-bearing formation.

In embodiment dispersions, a medium of carbon dioxide that is at the critical state or in a supercritical state suspends the prior-discussed embodiment capsules. The critical temperature for carbon dioxide is approximately 31.1° C.; the critical pressure is approximately 8.38 MPa (megapascals). In some embodiment dispersions, the carbon dioxide is in a critical state. In some other embodiment dispersions, the carbon dioxide is in a supercritical state. Embodiment dispersions may include SCCO2 in a temperature range of from about 50° C. to about 100° C. Embodiment dispersions may include SCCO2 in a pressure range of from about 1500 psi (pounds per square inch) to about 5000 psi.

In some embodiment dispersions, the carbon dioxide medium may have a purity of at or greater than 90%. The purity of the carbon dioxide is determined before introduction of the capsules into the embodiment dispersion, the introduction of water into the carbon dioxide, or the introduction of the carbon dioxide into a subterranean formation, as any contact may introduce external impurities into the critical or supercritical carbon dioxide. In some embodiment dispersions, the carbon dioxide medium may have a density in a range of from about 0.8 to 0.9 g/mL.

Embodiment dispersions also include capsules as previously described. The capsules are stable in the critical and supercritical CO₂ environment. The 2D particle and aqueous solution do not physically or chemically degrade or disassociate due to the presence of the critical or supercritical CO₂.

Embodiment dispersions may include a percent volume of water as compared to the total volume of water and SCCO2. Embodiment dispersions may include from about 60 to 70 vol. % (volume percent) of water. A higher water content contributes to an increased density of embodiment dispersions, as water has a greater density than SCCO2 under formation conditions.

Embodiment dispersions may include any suitable amount of 2D particles. In some embodiments, dispersions may include up to 5.0 wt. % of 2D particles in terms of the total weight of the dispersion. Embodiment dispersions may have a lower limit of about 1.0, 1.5, 2.0, or 2.5 wt. % 2D particles, and an upper limit of about 5.0, 4.5, 4.0, 3.5, or 3.0 wt. % 2D particles, where any lower limit may be used in combination with any mathematically-compatible upper limit.

Embodiment dispersions may have a bulk density suitable for mitigating gravity override. Such dispersions may have a bulk density of from about 0.9 to 1.2 g/mL at formation conditions. Embodiment dispersions may include a range of from about 50 to 70 vol. % of embodiment capsules.

### Method of Forming a Dispersion

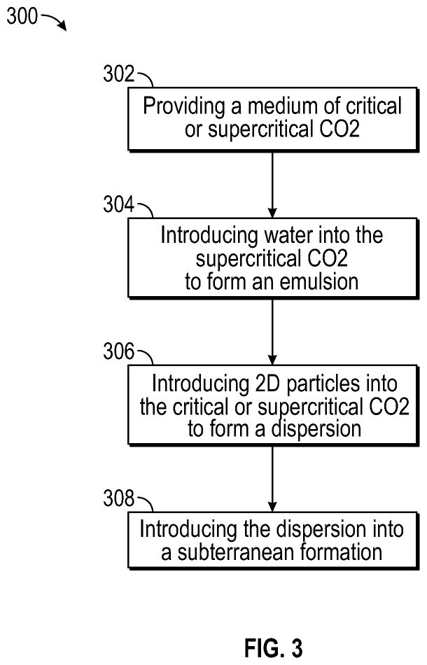

In another aspect, embodiments disclosed here relate to a method of making the previously-described dispersion. FIG. 3 is a block flow diagram of an embodiment method of making a dispersion 300.

The method 300 may include providing a medium of critical or supercritical carbon dioxide 302. In some embodiments, providing the medium may include introducing critical or supercritical carbon dioxide into a subterranean formation. In such cases, the dispersion may be formed in situ, that is, within the formation to be treated with the dispersion. As such, the treatment of the formation and the creation of the dispersion occur virtually simultaneously. In other embodiments, the dispersion is fabricated outside of a subterranean formation, such as on the surface or in a production facility, and introduced through an injection well.

The method 300 may include introducing water into the critical or supercritical carbon dioxide such that an emulsion of water in CO₂ forms 304. Embodiment SCCO2 may be in a temperature in in a range of from about 50° C. to about 100° C. and a pressure in a range of from about 1500 psi to about 5000 psi when water is introduced. The water may be introduced to SCCO2 by any suitable means in which the previously described temperatures and pressures may be maintained. For example, the water may be introduced by a pump configured to introduce fluids at a temperature and pressure greater than the temperature and pressure of the SCCO2, such by using a high pressure syringe pump. The water/SCCO2 may then be mixed using vigorous stirring to form am emulsion. If 2D particles are already present in the CO₂ as a dispersion, then the 2D particles encapsulate the aqueous solution and the dispersion forms.

Upon introducing an aqueous solution into a SCCO2 medium, an emulsion of water droplets in SCCO2 may be formed. However, such emulsions may not be stable for extended periods because water and SCCO2 naturally separate due to differences in polarity of the two fluids.

The method 300 may include introducing 2D particles into the critical or supercritical carbon dioxide 306. The SCCO2 medium in embodiment dispersions may be in a temperature in a range of from about 50° C. to about 100° C. and a pressure in a range of from about 1500 psi to about 5000 psi when 2D particles are added. Embodiment 2D particles may be added to embodiment dispersions as a dry powder. Embodiment 2D particles may be added to the CO₂ medium under vigorous stifling to evenly disperse the 2D particles. The mixture may then be stirred for about 30 to 60 minutes to form the dispersion.

In some embodiments, the water is added to the SCCO2 prior to the addition of the 2D particles to the SCCO2. If water is present in the CO₂ medium and emulsified, the embodiment dispersion may immediately form. The 2D particles described previously may be provided to the emulsion to encapsulate the aqueous solution micro- or nano-bubbles present, thereby mitigating the polarity difference, stabilizing the aqueous solution in the SCCO2 medium, and forming the dispersion from the emulsion of water and CO₂. In some embodiments, the 2D particles are added to the SCCO2 prior to the addition of the water to the SCCO2. If the aqueous solution is not present in the CO₂ medium, then a dispersion of 2D particles in the critical or supercritical CO₂ is formed. In some embodiments, the water and 2D particles may be introduced to the SCCO2 medium simultaneously.

When introduced into an aqueous solution in SCCO2 emulsion, the hydrophobic particles, such as the previously-described 2D particles, may collect at the interface between the aqueous solution and the SCCO2, if water is already present in the CO₂ medium. If water is not present, although not wanting to be bound by theory, it is believed that the 2D particles will likely be distributed fairly evenly throughout the CO₂ medium until water is introduced. When the aqueous solution is introduced, the 2D particles aggregate on the surface of the aqueous solution even though they are hydrophobic. As the 2D particles collect at the aqueous/SCCO2 interface, the aqueous solution is encapsulated and stabilized in the SCCO2 medium, similar to what is shown in FIG. 1. This 2D particle layer serves to encapsulate the aqueous solution.

Although not wanting to be bound by theory, it is believed that due to the hydrophobic nature of the embodiments of the 2D particles, Van der Walls forces may be strong between the CO₂ molecules in the SCCO2 and surfaces of the 2D particles. This may have the effect of CO₂ molecules affiliating with or adsorbing onto surfaces of the 2D particles. As such, CO₂ molecules may pack more tightly near the surface of a capsule as compared to molecules in the bulk SCCO2 medium. This may result in an increased bulk density for the capsule/SCCO2 dispersion versus a simple water/SCCO2 emulsion without the 2D particles.

### Method of Use in a Hydrocarbon-Bearing Formation

In another aspect, embodiments disclosed here relate to a method of using the previously-described embodiment dispersion in a hydrocarbon-bearing formation. As shown in FIG. 2, the embodiment dispersion comprising the embodiment capsules are shown traversing the pore structure of a reservoir.

As shown in FIG. 3, an embodiment method may include introducing the previously-described embodiment dispersion that comprises the embodiment capsules in critical or supercritical carbon dioxide into a subterranean formation, such as a hydrocarbon-bearing formation 308. Embodiment methods may include introducing a previously-formed embodiment dispersion having the previously-described embodiment capsules into a subterranean formation. In other embodiments, components of the dispersion may be introduced separately, meaning that the CO₂, aqueous solution and 2D particles may each be introduced separately into the formation, and embodiment dispersions may be formed in the subterranean formation in situ. In embodiment dispersions, components may be added to the formation in any order, as previously described. If introduced into the formation separately, the 2D particles may be suspended in a suitable solvent, such as oil or SCCO2 The 2D particles may also be suspended in water provided it has surfactants to assist in suspension of the 2D particles.

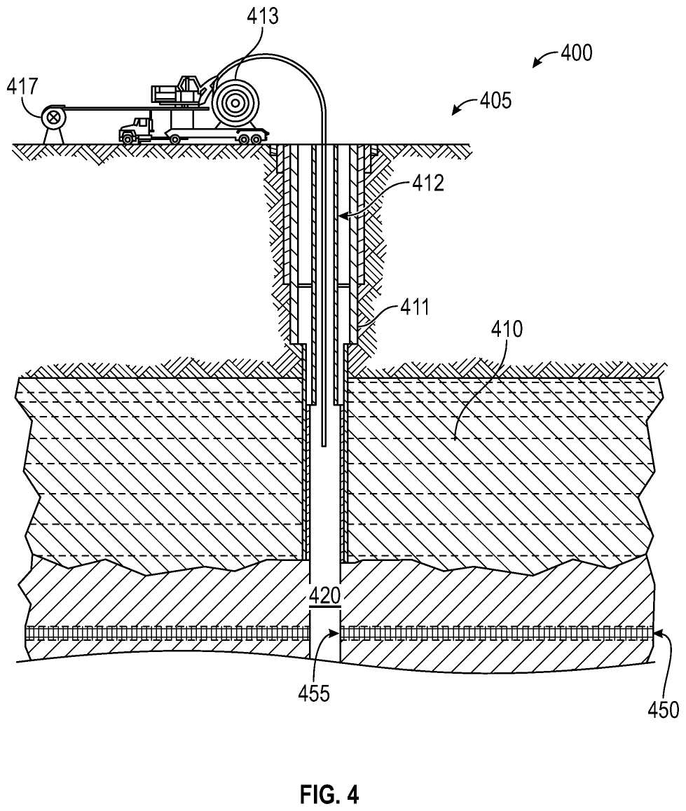

FIG. 4 is a diagram that illustrates a well environment 400 in accordance with one or more embodiments. Well environment 400 includes a subsurface 410. Subsurface 410 is depicted having a wellbore wall 411 both extending downhole from a surface 405 into the subsurface 410 and defining a wellbore 420. The subsurface 410 also includes target formation 450 to be treated. Target formation 450 has target formation face 455 that fluidly couples target formation 450 with wellbore 420 through wellbore wall 411. In this case, casing 412 and coiled tubing 413 extend downhole through the wellbore 420 into the subsurface 410 and towards target formation 450.

With the configuration in FIG. 4, the previously-described embodiment dispersion that comprises the embodiment capsules in critical or supercritical carbon dioxide may be introduced into the subsurface 410 towards target formation 450 via a pump 417 through the coiled tubing 413. In another embodiment, as previously described, the dispersion may be formed in situ, meaning components of the dispersion (CO₂, aqueous solution, 2D particles) may be introduced into the subsurface 410 separately via the pump 417 through the coiled tubing 413, forming the dispersion inside the target formation 450. In such embodiments, multiple pumps may be used to separately inject components of the dispersion.

Hydrocarbon-bearing formations may include any oleaginous fluid, such as crude oil, dry gas, wet gas, gas condensates, light hydrocarbon liquids, tars, and asphalts, and other hydrocarbon materials. Hydrocarbon-bearing formations may also include aqueous fluid, such as water and brines. Hydrocarbon-bearing formations may include portions thereof with pores sizes of from about 100 nm to 100 μm. As such, embodiment capsules have sizes in an appropriate range to traverse pores of hydrocarbon-bearing formations. Embodiment dispersions may be appropriate for use in different types of subterranean formations, such as carbonate, shale, sandstone and tar sands.

Embodiments of the present disclosure may provide at least one of the following advantages. As described previously, embodiment dispersions may have greater density than bulk supercritical CO₂. As such, embodiment dispersions may not have the gravity override challenges associated with SCCO2 in enhanced oil recovery applications. The SCCO2 dispersion may traverse deeper into target formations to treat portions of the formation that have not been treated or that have been bypassed by previous treatment techniques. The compositions and methods disclosed here may result in in greater oil recovery and may increase hydrocarbon production versus without the treatment.

When the word “approximately” or “about” are used, this term may mean that there can be a variance in value of up to ±10%, of up to 5%, of up to 2%, of up to 1%, of up to 0.5%, of up to 0.1%, or up to 0.01%.

Although only a few example embodiments have been previously described in detail, those skilled in the art will readily appreciate that many modifications are possible in the example embodiments without materially departing from the envisioned scope. Accordingly, all such modifications are intended to be included within the scope of this disclosure as defined in the following claims. In the claims, means-plus-function clauses are intended to cover the structures described as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims, except for those in which the claim expressly uses the words ‘means for’ together with an associated function.

What is claimed is:

1. A composition of matter comprising:
a dispersion of capsules in critical or supercritical carbon dioxide, the capsules comprising an aqueous solution encapsulated by 2-dimensional particles.

2. The composition of claim 1, where the capsules have an aqueous solution diameter in a range of from about 10 nm to 100 μm.

3. The composition of claim 1, where the 2-dimensional particles have a particle size in a range of from about 10 to 200 nm.

4. The composition of claim 1, where the 2-dimensional particles are selected from the group consisting of graphene, boron nitride, and combinations thereof.

5. The composition of claim 1, where the capsules have a diameter in a range of from about 10 nm to 100 μm.

6. The composition of claim 1, where the dispersion comprises in a range of from about 60 to 70 vol. % of the aqueous solution.

7. The composition of claim 1, where the dispersion comprises up to 5.0 wt. % of the 2-dimensional particles.

8. The composition of claim 1, where the dispersion has a bulk density in a range of from about 0.9 to 1.1 g/mL.

9. A method of making a dispersion of aqueous solution capsules, the method comprising:
providing a medium of critical or supercritical carbon dioxide;
introducing the aqueous solution into the critical or supercritical carbon dioxide medium; and
introducing a 2-dimensional particle into the critical or supercritical carbon dioxide medium.

10. The method of claim 9, where the aqueous solution is introduced into the critical or supercritical carbon dioxide medium via a pump configured to introduce fluids at a temperature and pressure greater than a temperature of the critical or supercritical carbon dioxide medium and a pressure greater than a pressure of the critical or supercritical carbon dioxide medium.

11. The method of claim 9, where the aqueous solution and the 2-dimensional particle are introduced into the critical or supercritical carbon dioxide medium simultaneously.

12. The method of claim 9, where the aqueous solution is introduced into the critical or supercritical carbon dioxide medium prior to the 2-dimensional particle being into the critical or supercritical carbon dioxide medium.

13. The method of claim 9, where the is 2-dimensional particle introduced into the critical or supercritical carbon dioxide medium prior to the aqueous solution being into the critical or supercritical carbon dioxide medium.

14. The method of claim 9, where the 2-dimensional particle has a particle size in a range of from about in a range of from 10 to 200 nm.

15. The method of claim 9, where the dispersion has a bulk density in a range of from about 0.9 to 1.1 g/mL.

16. A method of treating a hydrocarbon-bearing formation comprising:
introducing into the hydrocarbon-bearing formation a dispersion of aqueous solution capsules in a medium of critical or supercritical carbon dioxide, the aqueous solution capsules comprising an aqueous solution encapsulated by 2-dimensional particles.

17. The method of claim 16, where the 2-dimensional particles have a particle size in a range of from about 10 to 200 nm.

18. The method of claim 16, where the 2-dimensional particles are hydrophobic.

19. The method of claim 16, where the dispersion comprises in a range of from about 60 to 70 vol. % of the aqueous solution.

20. The method of claim 16, where the dispersion comprises up to 5.0 wt. % of the 2-dimensional particles.
